(19) United States
(12) Patent Application Publication
(10) Pub. No.: US 2004/0093383 A1
(43) Pub. Date: May 13, 2004

(54) System and method for managing network devices via e-mail

(76) Inventors: Yu-Yuan Huang, Tu-chen (TW); Cheng-Ling Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/334,777

(22) Filed: Dec. 31, 2002

(30) Foreign Application Priority Data
Nov. 8, 2002 (TW) 91132846

(51) Int. Cl. G06F 15/16

(52) U.S. Cl. 709/206; 709/229

(57) ABSTRACT

A system and method for managing network devices via e-mail that accomplishes sending management commands to the management proxy device (140) and receiving status information on the managed device (150) via e-mail in a network management system. The system for managing network devices via e-mail comprised: at least one management base (100) that runs an e-mail client side program (113) as a network management tool to send e-mails containing management commands; at least one management proxy device that runs an e-mail service module (146) for receiving and analyzing e-mails containing management commands, and for sending e-mails containing status information on a managed device, said e-mail service module comprising an e-mail receiving sub-module (1461), a decryption sub-module (1462), a status information reporting sub-module (1463) and an e-mail sending sub-module (1464); and an e-mail server (160) that receives e-mails from the management base and the management proxy device.

### BACKGROUND OF THE INVENTION

1. Field of the Invention

The present invention relates to a system and method for managing network devices, and especially to a system and method for managing network devices via e-mail.

2. Prior Art

Following the widespread use of TCP/IP (Transfer Control Protocol/Internet Protocol) in the 1970s, the management of network devices has become of great import. In the late 1980s and early 1990s, the rapid development of networks made monitoring of network devices a necessary for many organizations. However, increasing numbers of networks and network devices gave rise to various different proprietary network management devices. An urgent need has arisen for a universal code of network management and for relevant management devices. Recently SNMP (Simple Network Management Protocol) has been widely used as a code of network management. All current network monitoring program and management proxy devices support SNMP. SNMP is the standard way of checking that managed devices on a network are operating properly.

The four important parts needed for implementing SNMP are a management base, a management proxy, a management information base, and a network monitoring program. The management base is usually a host computer equipped with the network monitoring program, which is used as a working studio for network administrators. The management base has network communication to send management commands and retrieve status information on managed devices. The management proxy is usually a kind of network device such as an SNMP adapter. The management proxy receives management commands from the management base, obtains information on a status of its respective managed device, and sends such information back to the management base.

Normally, an intranet of a large enterprise comprises a plurality of local area networks, where numerous routers, printers, UPSs (Uninterruptable Power Supplies) and so on need to be managed. With improvements in network technology, devices like printers and UPSs no longer only serve respective local computers, but instead are shared devices serving both local computers and remote computers via networks. In order to achieve remote monitoring and management of these shared devices in networks, either of two means are normally adopted. One means is installing SNMP adapters in the shared devices. The devices having SNMP adapters can act as nodes connected in the networks, and can accept management commands from remote management bases. The other means is installing a management proxy program in one of the computers that is connected with the shared device. The management proxy program also supports SNMP, and enables a computer to serve as a SNMP proxy.

As the popularity of networks has increased, so too has the issue of safety of networks. Normally, each local area network in the intranet has a firewall installed in its respective network server, to safeguard the resources in the relevant local area network. Even though this achieves network safety, it also creates a new problem regarding remote monitoring and management. Generally, communication between a management base and a management proxy via networks depends on SNMP, and SNMP requires a special port in the network server. If the firewall blocks use of the port needed by SNMP, the communication between the management base and the management proxy is also blocked. The management proxy cannot receive management commands from the management base, and cannot feed back status information on the managed device.

U.S. Pat. No. 6,430,613 discloses a solution for network management, in which the communication between the management base and the management proxy is simply based on SNMP in order. This solution accomplishes remote monitoring and management of managed devices. However, in practice, settings of firewalls render said solution quite rudimentary. The management base cannot employ its network monitoring program without the support of SNMP in firewalls.

### SUMMARY OF THE INVENTION

Accordingly, it is a general object of the present invention to provide a system and method for managing network devices via e-mail whereby a management base can communicates with a management proxy regardless of firewall settings in a network.

In order to achieve the aforementioned object, the present invention provides a system for managing network devices via e-mail, the system comprising at least one management base, at least one management proxy device, at least one managed device, and an e-mail server. Wherein, the at least one management base runs an e-mail client side program as a network management tool to send e-mails containing management commands. The at least one management proxy device runs an e-mail service module for receiving and analyzing e-mails containing management commands, and for sending e-mails containing information on a status of a managed device. Each managed device corresponds with one management proxy device. And the e-mail server receives e-mails from the at least one management base and the at least one management proxy device.

The present invention also provides a method for managing network devices via e-mail, the method comprising the following steps: (i) running an e-mail client side program to send an e-mail containing management commands to an e-mail server; (ii) running an e-mail service module to receive the e-mail containing management commands from the e-mail server; (iii) determining a validity of the received e-mail, and determining a reserved time of the received e-mail in the e-mail server if the received e-mail is valid; (iv) executing management commands contained in the valid received e-mail if the valid received e-mail has not been read yet; (v) receiving information on a status of a managed device returned by a management proxy device; (vi) generating an e-mail containing status information on the managed device, and sending the generated e-mail to the e-mail server; and (vii) running the e-mail client side program to receive the e-mail containing status information on the managed device from the e-mail server.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of architecture of a system for managing network devices via e-mail in accordance with a preferred embodiment of the present invention, the system comprising a plurality of management bases, a network, a plurality of management proxy devices, a plurality of managed devices, and an e-mail server;

FIG. 2 is a block diagram of network management tools of any management base of the system of FIG. 1;

FIG. 3 is a block diagram of function modules of any one management proxy device of the system of FIG. 1, also showing connectivity of the management proxy device with other parts of the system of FIG. 1;

FIG. 4 is a block diagram of function modules of an e-mail service module of any management proxy device of the system of FIG. 1, also showing connectivity of the e-mail service module with the email server and with a corresponding main control module of the management proxy device; and

FIGS. 5A and 5B cooperatively comprise a flow chart of a preferred method for managing network devices via e-mail.

### DETAIL DESCRIPTION OF PREFERRED EMBODIMENTS OF THE INVENTION

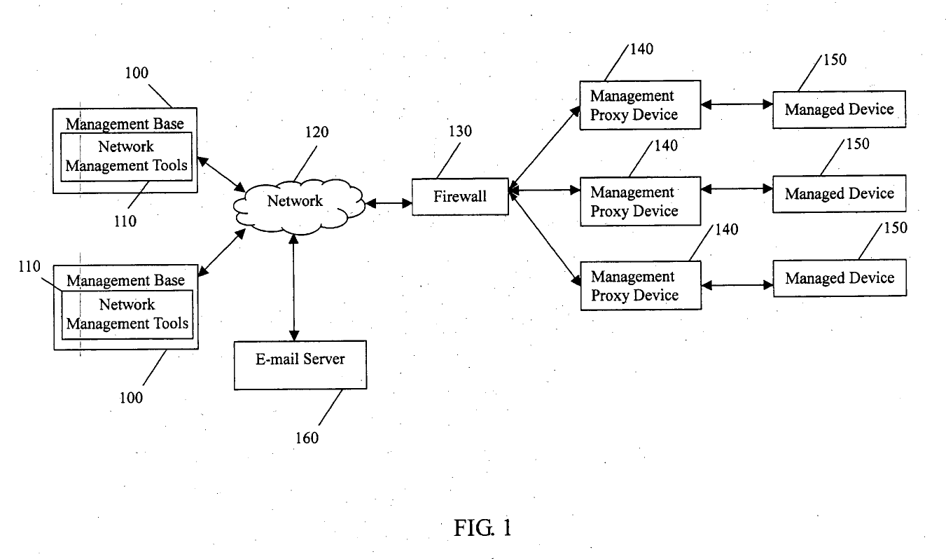

FIG. 1 is a schematic diagram of architecture of a system for managing network devices via e-mail in accordance with a preferred embodiment of the present invention. The system comprises at least one management base 100, a network 120, at least one management proxy device 140, at least one managed device 150, and an e-mail server 160.

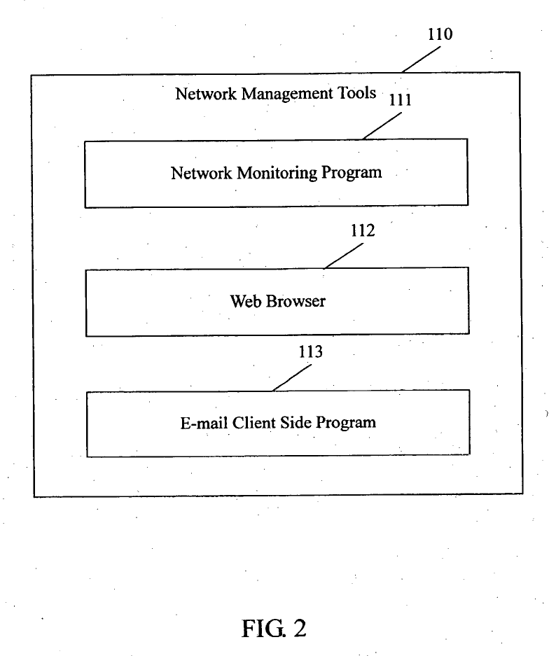

Each management base 100 normally is a computer host equipped with several network management tools 110. The computer host may be any appropriate type of computer such as an Apple computer, an IBM (International Business Machines) or IBM compatible computer, or a UNIX workstation. In order to communicate with the management proxy device 140, the management base 100 is equipped with at least one network communication protocol such as SNMP (Simple Network Management Protocol) that supports network management, HTTP (Hypertext Transfer Protocol) that supports web service, or POP3 (Post Office Protocol 3) and SMTP (Simple Mail Transfer Protocol) that cooperatively support e-mail service. The network management tools 110 necessarily use the relevant network communication protocols to accomplish network management. This is described in more detail below with reference to FIG. 2.

The network 120 is the Internet, an intranet, or a wide area network that comprises a plurality of local area networks connected together via routers and switches. Each management base 100 and each management proxy device 140 are nodes respectively connected in the network 120. Via the network 120, at least one management base 100 communicates with at least one management proxy device 140 distributed in the network 120, and accomplishes remote monitoring and management of at least one managed device 140.

The firewall 130 is a combination of any appropriate type of machine and software as are known in this art. The firewall 130 is used to protect devices in relevant local area networks such as the management proxy devices 140. Each management proxy device 140 needs to log on the firewall 130 firstly, and then connects with the network 120 via the firewall 130. Also, each management base 100 communicates with one or more management proxy devices 140 via the firewall 130.

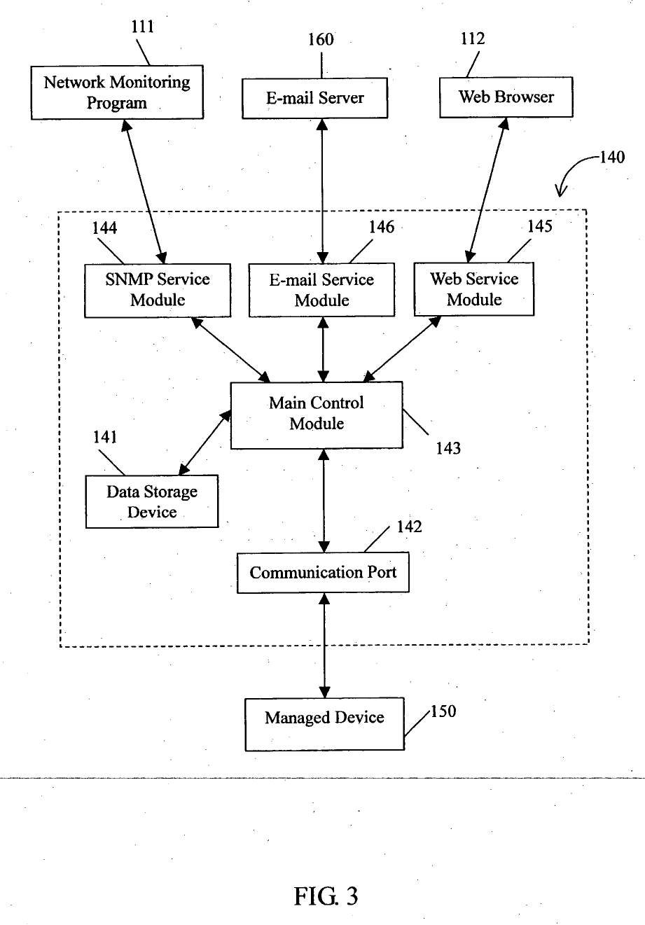

Each management proxy device 140 is any appropriate type of network device such as a computer equipped with a management proxy program, a switch or router providing network management functions, or a network adapter supporting SNMP. In the preferred embodiment of the present invention, the management proxy device 140 is simply an SNMP adapter. The SNMP adapter further supports HTTP to provide monitoring of web pages, and supports POP3 and SMTP to receive and send e-mails. This is described in more detail below with reference to FIG. 3.

Each managed device 150 may be any kind of network shared device. In the preferred embodiment of the present invention, each managed device 150 is a UPS. Each managed device 150 is connected with one management proxy device 140, and receives management commands from at least one management base 100 via the management proxy device 140.

The e-mail server 160 is any appropriate type of computer equipped with e-mail server side software. The e-mail server 160 functions as a middle layer of communication via e-mail. Each management base 100 and each management proxy device 140 have a respective e-mail account in the e-mail server 160. For example, on one side, one management base 100 sends e-mails containing management commands to the relevant e-mail account of the management proxy device 140, and receives e-mails containing status information on the managed device 150 from the e-mail account of the management proxy device 140. On the other side, the management proxy device 140 receives e-mails containing management commands from its e-mail account, and sends e-mails containing status information on the managed device 150 to the e-mail account of the management base 100.

FIG. 2 is a block diagram of network management tools 110 of any management base 100 of the system of FIG. 1. As is described in detail below, the management base 100 is a working studio for managing network devices, and installs the network management tools 110 and the relevant network communication protocols. The network management tools 110 comprise a network monitoring program 111, a web browser 112, and an e-mail client side program 113.

The network monitoring program 111 is any appropriate type of software that is known in the art, such as Open View, Net View and Sun Net Manager. The network monitoring program 111 uses SNMP to communicate with the management proxy device 140.

The web browser 112 is Internet Explorer 4.0 or Netscape 4.0 or later versions thereof, or any other browser which supports Java Applet. In the preferred embodiment of the present invention, network administrators use the web browser 112 to log on monitoring web pages stored in one management proxy device 140. Network administrators can enable an e-mail service for the relevant management proxy device 140 via the web pages. That is, network administrators can set an own e-mail account and password for the management proxy device 140, an IP (Internet Protocol) address of the e-mail server 160, group identification of service targets, and the other working parameters. The web browser 112 uses HTTP to communicate with the management proxy device 140.

The network monitoring program 111 and the web browser 112 as described above are both known in the art of network management.

The management base 100 installs the e-mail client side program 113, and the necessary network communication protocols of POP3 and SMTP. In this way, the e-mail server 160 functions as the middle layer of communication between the management base 100 and the management proxy device 140. Because ports used by POP3 and SMTP cannot be blocked by the firewall 130, the management base 100 and the management proxy device 140 can send and receive e-mails via the e-mail server 160 wherever the e-mail server 160 is located in the network 120. For example, the e-mail server 160 may be located in the same local area network as the management base 100, or in the same local area network as the management proxy device 140. In either case, the e-mail server 160 can receive e-mails via the firewall 130 from both the management base 100 and the management proxy device 140.

As described above, in the management base 100, network administrators firstly use the web browser 112 to enable the e-mail service for the management proxy device 140 and complete the relevant working parameters. Then the network administrators use the e-mail client side program 113 to send e-mails containing management commands to the relevant e-mail account of the management proxy device 140.

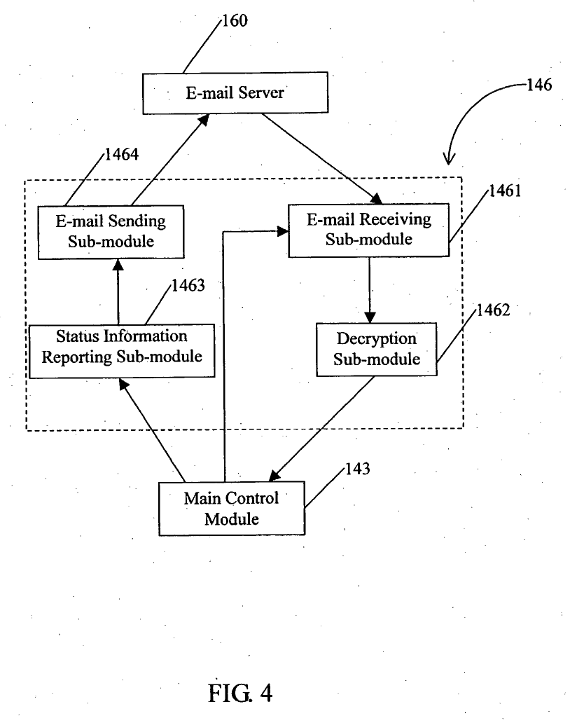

In order to guarantee security of communication, the e-mail client side program 113 firstly encrypts e-mails that contain management commands. The management proxy device 140 decrypts e-mails containing encrypted management commands. The encryption and decryption are performed according to any appropriate method known in the art. Decryption by the management proxy device 140 is described in more detail below with reference to FIG. 4.

FIG. 3 is a block diagram of function modules of any one management proxy device 140, also showing connectivity of the management proxy device 140 with other parts of the system of FIG. 1. The network management tools 110 of the management proxy device 140 need to support the functional modules in order that the management proxy device 140 can work. The management proxy device 140 comprises a data storage device 141, a communication port 142, a main control module 143, an SNMP service module 144, a web service module 145, and an e-mail service module 146.

The storage device 141 is used to store important information on the management proxy device 140, in case of a power cut. The storage device 141 may be an EEPROM (electrically erasable programmable read-only memory) that stores information on management commands, warning information on the managed device 150, user information on the management bases 100 and so on. Alternatively, the storage device 141 may be a flash memory that stores application programs such as the e-mail service module 146.

The communication port 142 is used for communication between the management proxy device 140 and the managed device 150. Monitoring signals are obtained and management commands are sent via the communication port 142.

The main control module 143 is used to obtain status information on the managed device 150 in real time, and calls the SNMP service module 144, the web service module 145, and the e-mail service module 146 respectively to execute relevant operations. In the preferred embodiment of the present invention, because the managed device 150 is a UPS, the main control module 143 uses UPS communication protocol. The main control module 143 obtains management commands received by the modules 144, 145, 146, and encodes obtained management commands according to UPS communication protocol in order to communicate with the managed device 150. In addition, the main control module 143 obtains current values of monitoring signals from the managed device 150 via the communication port 142, and decodes obtained values according to UPS communication protocol into status information on the managed device 150.

The SNMP service module 144 is the interface for one or more management bases 100 using respective network monitoring programs 111 to monitor the managed device 150. The SNMP service module 144 uses SNMP.

The web service module 145 is the interface for one or more management bases 100 using respective web browsers 112 to monitor the managed device 150. The web service module 145 uses HTTP.

The SNMP service module 144 and the web service module 145 described above are both known function modules in the art of network management.

The e-mail service module 146 is the interface for the management proxy device 140 to receive and analyze e-mails containing management commands. The e-mail service module 146 enables one or more management bases 100 to communicate with the management proxy device 140 via the e-mail server 160. As described above, network administrators firstly use the web browser 112 of a management base 100 to log on the monitoring web pages in the management proxy device 140, set relevant working parameters and enable the e-mail service for the management proxy device 140. The e-mail service module 146 receives e-mails containing management commands from the relevant e-mail account in the e-mail server 160 at the end of each of consecutive predefined periods. In the preferred embodiment of the present invention, each predefined period is 30 minutes.

FIG. 4 is a block diagram of function modules of the e-mail service module 146 of any management proxy device 140 of the system of FIG. 1, also showing connectivity of-the e-mail service module 146 with the email server 160 and with the corresponding main control module 143. The e-mail service module 146 comprises an e-mail receiving sub-module 1461, a decryption sub-module 1462, a status information reporting sub-module 1463, and an e-mail sending sub-sub-module 1464.

The e-mail receiving sub-module 1461 connects with the e-mail server 160 periodically, receives e-mails containing management commands from the relevant e-mail account, and analyzes the emails. The e-mail receiving sub-module 1461 mainly executes the following procedures: (1) trying to connect with the e-mail server 160 every 30 minutes, and waiting for a next call by the main control module 143 if the try was not successful; and logging on the relevant e-mail account every minute until successful logging on is attained, if and when said connection is successful; (2) determining respective validities of received e-mails containing management commands, sending respective contents of valid e-mails to the decryption sub-module 1462, and deleting all invalid e-mails; and (3) recording respective times of receipt of valid e-mails, in order to determine whether the valid e-mails exceed a predefined time limit. In the preferred embodiment of the present invention, the predefined time limit is 3 hours.

Wherein, the procedure of determining a validity of a received e-mail must keep to the two following rules. The first rule is that a title of a valid e-mail must comprises 14 non-blank ASCII characters, and start with “pwUPS.” If a current received e-mail satisfies the first rule, nine non-blank ASCII characters following “pwUPS” are summed up, and the result is stored in an 8-bit byte. Lowest 5 bits in said byte is retrieved as an integer, and the integer is used as an e-mail identification of the current received e-mail. An e-mail identification is in the range from 0 to 31.

The second rule is that a valid e-mail must be reserved in the relevant e-mail account for 3 hours; and that during this period, any other received e-mail whose e-mail identification is the same as said valid e-mail is invalid. The e-mail receiving sub-module 1461 determines whether the e-mail identification of the current received e-mail is the same as any valid e-mail reserved in the relevant e-mail account. If the result of the determination is yes, the current received e-mail is invalid and is deleted by the e-mail receiving sub-module 1461. If the result of the determination is no, the current received e-mail satisfies the second rule. Only received e-mails that satisfy both two rules are valid.

The procedure of recording times of receipt of each valid e-mail is completed by using a static array defined in the e-mail receiving sub-module 1461. The value of an e-mail identification is in the range from 0 to 31. The static array comprises 32 elements whose identifications correspond to the e-mail identifications respectively, and whose values represent respective times of receipt of valid e-mails. Each time the e-mail receiving sub-module 1461 reads an e-mail in a relevant e-mail account, the e-mail receiving sub-module 1461 adds 1 to a value of the corresponding element for that e-mail. If the value of the corresponding element for an e-mail is 6, this means that the e-mail has exceeded the pre-defined time limit (6 receipts×30 minutes=3 hours). Accordingly, the e-mail receiving sub-module 1461 deletes the e-mail, and sets the value of the corresponding element to 0.

The decryption sub-module 1462 decrypts contents of e-mails containing management commands, and sends the decrypted management commands to the main control module 143 for execution. Decryption by the decryption sub-module 1462 is the converse of the encryption performed by the corresponding e-mail client side program 113.

The status information reporting sub-module 1463 receives current values of status information on the managed device 150 sent by the main control module 143, and generates a status information report of the managed device 150.

The e-mail sending sub-module 1464 receives status information reports on the managed device 150 sent by the status information reporting sub-module 1463, and generates e-mails containing status information on the managed device 150. The emails are generated according to a reply letter format stored in the storage device 141, and relevant return addresses in headers of received e-mails. The e-mail sending sub-sub-module 1464 sends the generated e-mails to the e-mail server 160.

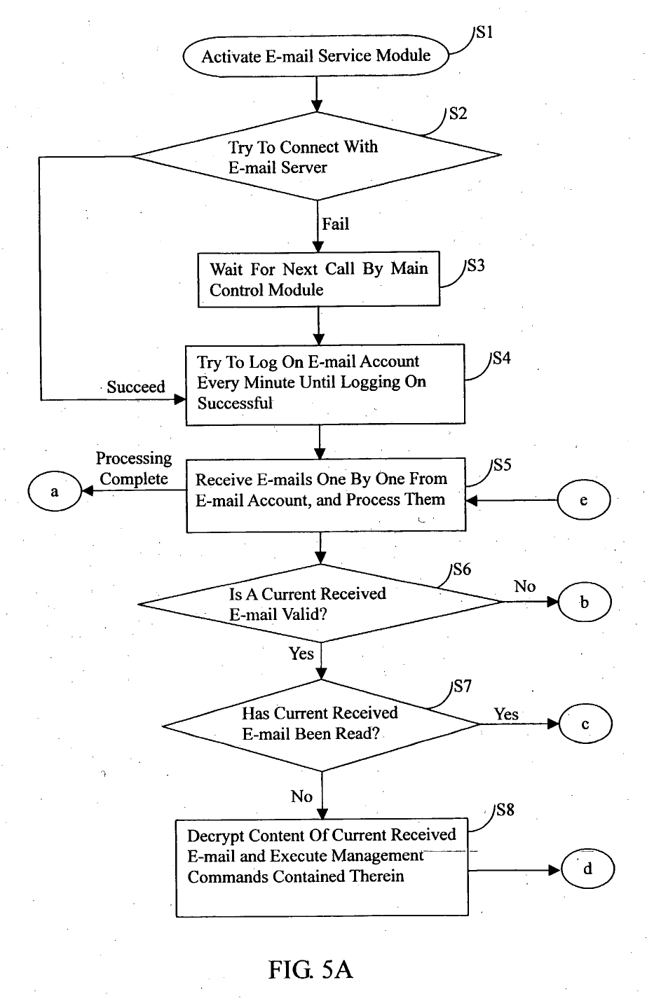

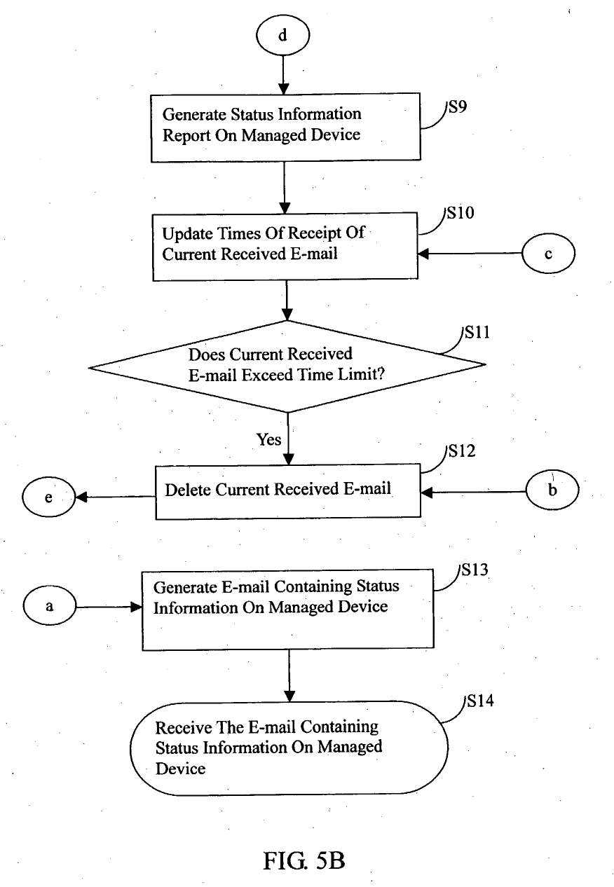

FIGS. 5A and 5B cooperatively comprise a flow chart of a preferred method for managing network devices via e-mail. The method is implemented in the above-described system for managing network devices via e-mail. As described above, the e-mail receiving sub-module 1461 of the e-mail service module 146 uses the static array to record respective times of receipt of valid e-mails. In FIGS. 5A and 5B, the static array is expressed as A[32], and initial values of elements in A[32] are 0.

Firstly, network administrators use the web browser 112 to log on the monitoring web pages in the management proxy device 140, and set relevant working parameters in order to activate the e-mail service module 146 in the management proxy device 140. The network administrators then use the e-mail client side program 113 to send e-mails containing management commands to the e-mail server 160 (Step S1). The main control module 143 calls the e-mail service module 146 at the end of a 30-minute period. Then the e-mail receiving sub-module 1461 tries to connect with the e-mail server 160 (Step S2). If connection fails, the e-mail service module 146 waits for a next call by the main control module 143 (Step S3). If connection succeeds, the e-mail receiving sub-module 1461 tries to log on the e-mail account of the management proxy device 140 every minute until logging on is successful (Step S4). The e-mail receiving sub-module 1461 receives e-mails one by one from the e-mail account (Step S5), and processes the received emails as described below. The e-mail receiving sub-module 1461 determines respective validities of current received e-mails. Firstly, the e-mail receiving sub-module 1461 determines whether the title of a received e-mail comprises 14 non-blank ASCII characters, and starts with “pwUPS.” If the result of the first determination is yes, the e-mail receiving sub-module 1461 uses 9 non-blank ASCII characters after “pwUPS” to generate the e-mail identification of the current received e-mail. If the result of the first determination is no, the current received e-mail is invalid and the procedure proceeds directly to Step S12 described below. Secondly, the e-mail receiving sub-module 1461 determines whether the e-mail identification of the current received e-mail is the same as any valid e-mail reserved in the relevant e-mail account (Step S6). If the result of the second determination is yes, the current received e-mail is invalid and the procedure proceeds directly to Step S12 described below. If the result of the second determination is no, the e-mail receiving sub-module 1461 reads the value of the corresponding element in A[32] according to the e-mail identification. As described above, A[32] comprises elements whose identifications correspond to e-mail identifications, and whose values represent respective times of receipt of e-mails. If the value of the corresponding element in A[32] is not zero, this means that the current received e-mail has been read, and the procedure proceeds directly to Step S10 described below (Step S7). If the value of the corresponding element in A[32] is zero, this means that the current received e-mail has not been read, and the decryption sub-module 1462 decrypts the content of the current received e-mail. Then the main control module 143 executes management commands contained in the current received e-mail (Step S8). The status reporting sub-module 1463 receives current values of status information on the managed device 150 sent by the main control module 143, and generates a status information report of the managed device 150 (Step S9). The e-mail receiving sub-module 1461 adds 1 to the value of the corresponding element in A[32] in order to update times of receipt of the current received e-mail (Step S11). The e-mail receiving sub-module 1461 determines whether the current received e-mail exceeds the predetermined time limit, according to the value of the corresponding element in A[32] (Step S11). If the result of the determination is yes, the e-mail receiving sub-module 1461 deletes the current received e-mail from the relevant e-mail account, and sets the value of the corresponding element in A[32] to zero (Step S12). The procedure then returns to Step S5. If and when the e-mail receiving sub-module 1461 has received and processed all e-mails, the procedure proceeds directly to Step S13 (Step S5). The e-mail sending sub-module 1464 obtains a reply letter format stored in the storage device 141 and the reply address in the header of the current received e-mail, generates an e-mail containing status information on the managed device 150, and sends the e-mail to the e-mail server 160 (Step 13). Network administrators use the e-mail client side program 113 to receive the e-mail containing the status information on the managed device 150 from the relevant e-mail account of the management base 100 (Step S 14).

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for managing network devices via e-mail, the system comprising at least one management base, at least one management proxy device, at least one managed device, and an e-mail server, wherein:
the at least one management base runs an e-mail client side program as a network management tool to send e-mails containing management commands;
the at least one management proxy device runs an e-mail service module for receiving and analyzing e-mails containing management commands, and for sending e-mails containing information on a status of a managed device;
each managed device corresponds with one management proxy device; and
the e-mail server receives e-mails from the at least one management base and the at least one management proxy device.

2. The system of claim 1, wherein the e-mail service module comprises an e-mail receiving sub-module that receives e-mails containing management commands from the e-mail server, determines validities of the received e-mails, and determines reserved times of valid e-mails.

3. The system of claim 1, wherein the e-mail service module comprises a decryption sub-module that decrypts contents of e-mails containing management commands.

4. The system of claim 1, wherein the e-mail service module comprises a status information reporting sub-module that receives current values of status information on the corresponding managed device, and generates a status information report.

5. The system of claim 1, wherein the e-mail service module comprises an e-mail sending sub-module that generates e-mails containing status information on the corresponding managed device, and sends said generated e-mails to the e-mail server.

6. The system of claim 1, wherein the at least one management proxy device further comprises a data storage device that stores the e-mail service module.

7. The system of claim 1, further comprising a network wherein the at least one management base, the at least one management proxy device and the e-mail server are connected as nodes.

8. A method for managing network devices via e-mail, the method comprising the following steps:
(a) running an e-mail client side program to send an e-mail containing management commands to an e-mail server;
(b) running an e-mail service module to receive the e-mail containing management commands from the e-mail server;
(c) determining a validity of the received e-mail, and determining a reserved time of the received e-mail in the e-mail server if the received e-mail is valid;
(d) executing management commands contained in the valid received e-mail if the valid received e-mail has not been read yet;
(e) receiving information on a status of a managed device returned by a management proxy device;
(f) generating an e-mail containing status information on the managed device, and sending the generated e-mail to the e-mail server; and
(g) running the e-mail client side program to receive the e-mail containing status information on the managed device from the e-mail server.

9. The method of claim 8, wherein step (a) further comprising the step of: encrypting a content of the e-mail containing management commands before sending said e-mail to the e-mail server.

10. The method of claim 8, wherein step (c) further comprises the step of: multiplying a predefined period of time between regular connections of the e-mail service module to the e-mail server by a number of times of receipt of the received e-mail to determine the reserved time of the received e-mail in the e-mail server.

11. The method of claim 9, wherein step (d) further comprises the step of: decrypting the content of the valid received e-mail in order to obtain management commands contained in the valid received e-mail.

12. The method of claim 8, wherein step (f) further comprises the step of: generating the e-mail containing status information on the managed device according to a reply letter format.

13. A method for managing network devices via e-mail, the method comprising the following steps:
(a) providing a system with one management base, one management proxy device, one managed device, and one e-mail server;
(b) sending e-mails, from said management base, containing management commands;
(c) receiving and analyzing said e-mails, one by one, via said management proxy device;
(d) deleting the e-mail if said e-mail is invalid, or
(e) decrypting content of said e-mail and executing said management command thereof if said e-mail is valid and has not been read, or
(f) updating time of said e-mail to see whether said e-mail exceeds time limit if said e-mail is valid and has been read; and
(g) deleting the e-mail if said e-mail exceeds time limit in step (f);
(h) generating a status information report on the managed device after executing step (e), and then followed by steps (f) and (g).
